(19) United States
(12) Patent Application Publication
(10) Pub. No.: US 2012/0086738 A1
(43) Pub. Date: Apr. 12, 2012

(54) DISPLAY DEVICE AND CONTROL METHOD

(76) Inventor: Masayoshi SHIMIZU, Kawasaki (JP)

(21) Appl. No.: 13/328,511

(22) Filed: Dec. 16, 2011

Related U.S. Application Data
(63) Continuation of application No. PCT/JP2009/062907, filed on Jul. 16, 2009.

(51) Int. Cl. G09G 3/36; G09G 5/10

(52) U.S. Cl. 345/690; 345/102

(57) ABSTRACT

In a display device (200), a reduced-image generating unit (242) divides an input image into a plurality of areas, and an emission-intensity adjustment unit (243) compares the brightness distribution of an area with the emission distribution of each light source and sets an emission intensity. The emission-intensity adjustment unit (243), in order to set the emission intensity of a light source (220), determines the maximum and minimum values of the brightness values included in the main irradiation area of the light source (220), calculates the adjustment limit on the basis of the determined maximum and minimum values, and adjusts the emission intensity of the light source within the range of the adjustment limit.

### CROSS-REFERENCE TO RELATED APPLICATION

This application is a continuation of International Application No. PCT/JP2009/062907, filed on Jul. 16, 2009, the entire contents of which are incorporated herein by reference.

### FIELD

The embodiments discussed herein are directed to a display device, or the like.

### BACKGROUND

A liquid crystal display device includes a light control unit (liquid crystal panel) that can change the transmission state of light and includes a light source (backlight) that supplies light to the back side of the light control unit. The liquid crystal display device turns on the light source and controls the transmission rate of light through the light control unit in accordance with the displayed content so as to display arbitrary images.

In a technology for supplying light to a light control unit, each light source is divided in a grid pattern and the light sources are arranged on the back side of the light control unit in the grid pattern so that the light sources, which have separate irradiation areas, feed light to the light control unit. In contrast, there is a known technology in which the irradiation areas of the light sources are not separated and the light sources with overlapping irradiation areas are arranged on one of the sides of the light control unit so that the light is fed to the light control unit.

In the technology for feeding light to the light control unit by using the light sources with separate irradiation areas, low assembly accuracy or inappropriate adjustment of the emission intensity of each light source may cause the brightness to be visibly uneven. Thus, there is a disadvantage in that the manufacturing cost is increased in order to prevent the brightness from being visibly uneven. In the technology for supplying light to the light control unit by using light sources whose irradiation areas are not separated, because individual light sources have ambiguous irradiation areas, low assembly accuracy or low adjustment accuracy of emission intensity hardly causes the brightness to be visibly uneven. Thus, the manufacturing cost is not increased in order to prevent the brightness from being visibly uneven.

It is known that a liquid crystal display device allows the power consumption to be reduced because the emission intensity of a light source is changed in accordance with a change in successive images to be displayed. If the emission intensity of the light source is significantly changed, the change in the emission intensity is visibly recognized independently of any change in the images, which results in the occurrence of flicker. Such flicker is undesirable because it makes a viewer of the images feel tired or dizzy. For this reason, there is a known technology in which, in order to offset a change in the emission intensity of a light source, an input image is corrected and the corrected image is overlapped with an emission pattern so that the occurrence of flicker is prevented.

Japanese Laid-open Patent Publication No. 2005-258403

Japanese Laid-open Patent Publication No. 2008-203292

### SUMMARY

According to an aspect of an embodiment of the invention, a display device includes a plurality of light sources whose irradiation areas are overlapped with one another; an image display area that includes areas that are pre-set for the respective light sources; a calculating unit that calculates an adjustment limit of the amount of emission of each of the light sources corresponding to each of the areas when a display target image is displayed, the adjustment limit being calculated on the basis of the irradiation brightness of the area that is obtained when the previous display target image of the display target image is displayed; and a control unit that controls the amount of light of each of the light sources in accordance with the adjustment limit.

The object and advantages of the embodiment will be realized and attained by means of the elements and combinations particularly pointed out in the claims.

It is to be understood that both the foregoing general description and the following detailed description are exemplary and explanatory and are not restrictive of the embodiment, as claimed.

### BRIEF DESCRIPTION OF DRAWINGS

FIG. 1 is a block diagram that illustrates the configuration of a display device according to a first embodiment;

FIG. 2 is a block diagram that illustrates the configuration of a display device according to a second embodiment;

FIG. 3 is a diagram that illustrates the emission pattern of each light source;

FIG. 4 is a block diagram that illustrates the configuration of an emission-intensity adjusting unit;

FIG. 5 is a diagram that illustrates an example of area division of a reduced image;

FIG. 6 is a diagram that illustrates an example of an emission pattern;

FIG. 7 is a three-dimensional graph of the emission pattern illustrated in FIG. 6;

FIG. 8 is a graph that illustrates an example of a comparison between an emission pattern and an image;

FIG. 9 is a diagram that illustrates an example of the main irradiation area of a light source;

FIG. 10 is a diagram that illustrates an example of an irradiation area that has been subdivided into smaller areas;

FIG. 11 is a flowchart that illustrates the steps of a process for adjusting the emission intensity;

FIG. 12 is a flowchart that illustrates the steps of a decrease-amount adjustment process

FIG. 13 is a flowchart that illustrates the steps of an increase-amount adjustment process;

FIG. 14 is a diagram that illustrates an example of area division to select a light source that is located closest to the area for which the amount of light is most insufficient;

FIG. 15 is a flowchart that illustrates the steps of a process for calculating the adjustment limit; and

FIG. 16 is a functional block diagram that illustrates a computer that performs a display control program.

### DESCRIPTION OF EMBODIMENTS

Preferred embodiments of the present invention will be explained with reference to the accompanying drawings. The present invention is not limited to these embodiments.

A liquid crystal has different gamma characteristics (gradation characteristics), a corrected image is sometimes not output with a predetermined brightness value. In such a case, a change in the emission intensity of a light source is not offset even though the corrected image is overlapped; therefore, the occurrence of flicker is not prevented. It is possible to take a measure to adjust the emission intensity of each light source without a temporally dynamic change in the brightness of each light source. Specifically, in accordance with the emission intensity of a light source in the previous frame, a limit is set on the range of adjustment of the emission intensity of the light source in the subsequent frame; thus, the emission intensity of the light sources is not dynamically changed and flicker is avoided.

In a display device that uses multiple light sources whose irradiation areas are not separated, because the irradiation areas of the light sources are overlapped with one another, the light is fed by multiple light sources. As a result, compared to the control over the light sources of the display device in which the irradiation areas of the light sources are separated, it is not effective to set a limit of the range of adjustment of the emission intensity of each light source in accordance with the emission brightness of each light source. This is because, even if each light source is individually adjusted, the irradiation from the other light sources causes a state with a higher-than-necessary brightness when a display target image is displayed.

### [a] First Embodiment

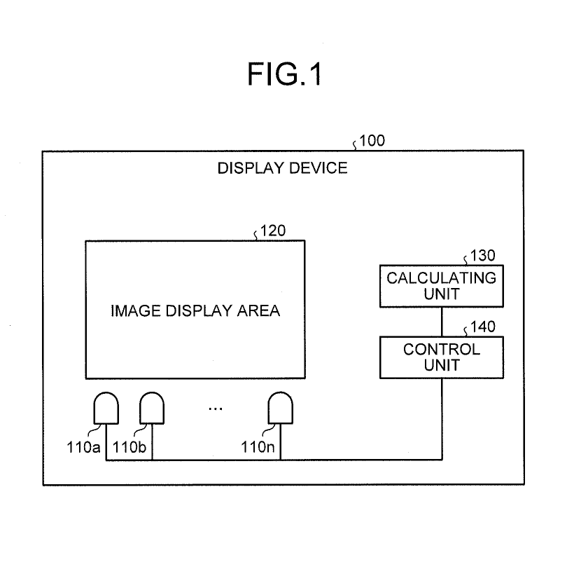

First, an explanation is given of the configuration of a display device according to a first embodiment. FIG. 1 is a block diagram that illustrates the configuration of the display device according to the first embodiment. As illustrated in FIG. 1, a display device 100 includes light sources 110a to 110n, an image display area 120, a calculating unit 130, and a control unit 140.

The light sources 110a to 110n emit light to the overlapped irradiation areas of the image display area 120. Although the light sources 110a to 110n are illustrated here for convenience of explanation, the display device 100 includes other light sources.

The image display area 120 includes areas that are pre-set for the respective light sources 110. The calculating unit 130 is a processing unit that calculates the adjustment limit of the amount of emission of a light source corresponding to an area during the display of a display target image in accordance with the irradiation brightness of the area during the display of the previous display target image of the display target image.

The control unit 140 is a processing unit that controls the amount of light of the light source 110 in accordance with the adjustment limit calculated by the calculating unit 130 on the amount of emission.

As described above, in the display device 100 according to the first embodiment, the calculating unit 130 calculates the adjustment limit of the amount of emission of the light source 110, and the control unit 140 adjusts the amount of emission of the light source 110 in accordance with the adjustment limit. Thus, in the display device that includes light sources whose irradiation areas are not separated, the adjustment limit can be set for a light source in consideration of the irradiation from the other light sources. As a result, it is possible to prevent flicker in a more effective manner.

### [b] Second Embodiment

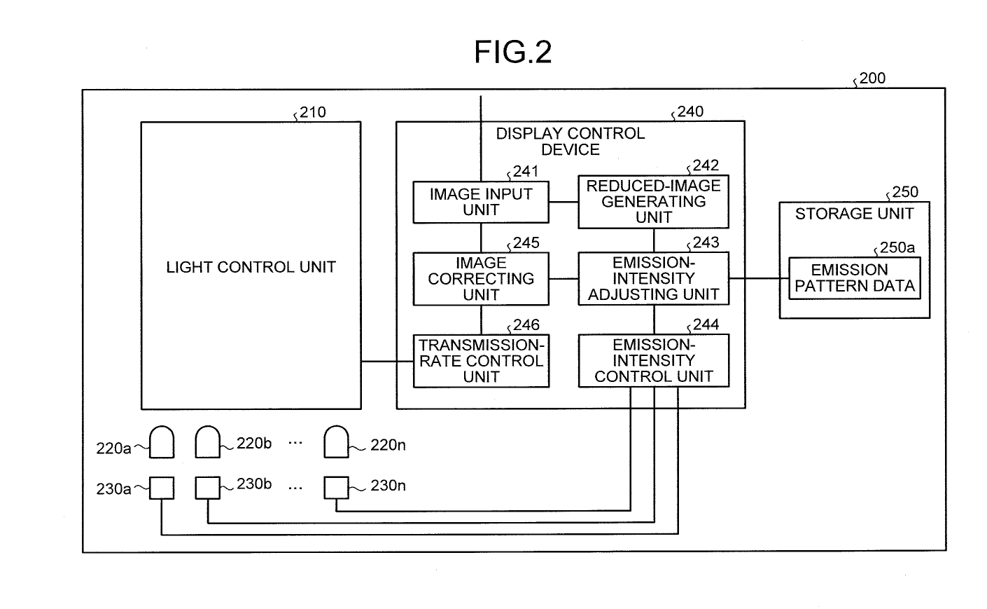

Next, an explanation is given of the configuration of a display device according to a second embodiment. FIG. 2 is a block diagram that illustrates the configuration of the display device according to the second embodiment. As illustrated in FIG. 2, a display device 200 includes a light control unit 210, light sources 220a to 220n, drivers 230a to 230n, a display control device 240, and a storage unit 250.

The light control unit 210 is, for example, a liquid crystal panel. The light control unit 210 changes the transmission rate of the light of each pixel. The light sources 220a to 220n are, for example, Light Emitting Diodes (LEDs). The light sources 220a to 220n feed light to the light control unit 210 from the back side thereof. In the display device 200, the light sources 220a to 220n are arranged, for example, along one (in FIG. 2, the lower side) of the sides of the light control unit 210 in a line on the back side of the light control unit 210. There is no need for mechanisms that separate the irradiation areas of the respective light sources. If the light sources 220a to 220n are arranged in a line, as illustrated in FIG. 2, the number of light sources 220 can be decreased and the cost of components can be reduced.

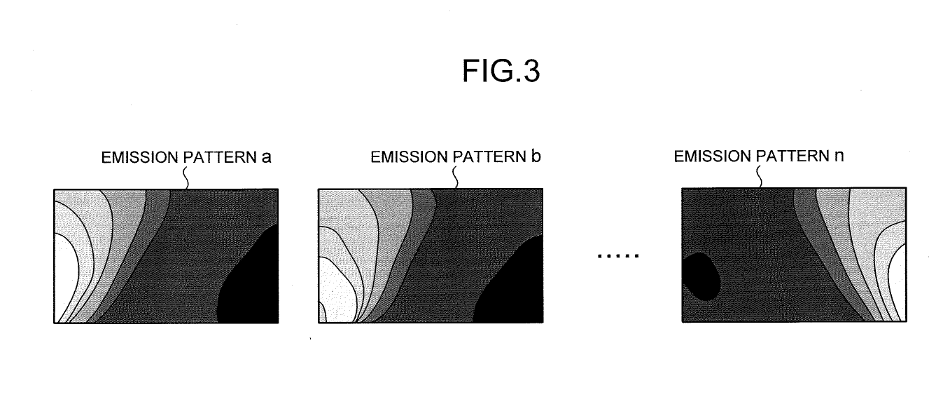

An explanation is given here of the emission pattern of each light source. FIG. 3 is a diagram that illustrates the emission pattern of each light source. The emission pattern a illustrated in FIG. 3 is the emission pattern of the light source 220a located on the extreme left of the light control unit 210. The emission pattern b illustrated in FIG. 3 is the emission pattern of the light source 220b located on the right side of the light source 220a. The emission pattern n illustrated in FIG. 3 is the emission pattern of the light source 220n located on the extreme right of the light control unit 210.

As illustrated in FIG. 3, the emission pattern of the light source 220 has a shape such that the area of the pattern is wider as the distance from the light source 220 increases. The light source 220 is arranged such that the emission pattern thereof is overlapped with the emission pattern of the different light source 220.

An explanation is given here with reference to FIG. 2 again. The drivers 230a to 230n drive the light sources 220a to 220n, respectively, in accordance with the control amount specified by the display control device 240. Although the light source 220 and the driver 230 are arranged with a one-to-one correspondence in the example illustrated in FIG. 2, a configuration may be such that multiple light sources 220 are driven by a single driver 230.

The display control device 240 is a control circuit that controls the light control unit 210 and the drivers 230a to 230n. The display control device 240 includes an image input unit 241, a reduced-image generating unit 242, an emission-intensity adjusting unit 243, an emission-intensity control unit 244, an image correcting unit 245, and a transmission-rate control unit 246.

The image input unit 241 is a processing unit that receives an input of an image to be displayed and temporarily stores therein the received input image. Here, a reduced image is generated in order to shorten the processing time; however, an input image may be used for subsequent processes without being changed. An input image has, for example, a size of 800×400. The reduced-image generating unit 242 is a processing unit that generates a reduced image of the input image received by the image input unit 241.

An explanation is given here of a process performed by the reduced-image generating unit 242 to generate a reduced image. The reduced-image generating unit 242 refers to the RGB (Red, Green, Blue) values that are assigned to each pixel of the input image and determines the maximum value of the RGB values. The reduced-image generating unit 242 then sets the maximum value as the brightness value corresponding to the pixel.

For example, if the RGB values assigned to a first pixel are (250, 100, 50), respectively, the maximum value is 250. In this case, the reduced-image generating unit 242 sets the brightness value of the first pixel to 250. The reduced-image generating unit 242 performs the above-described process on all the pixels included in the input image. By this process, one pixel value is set to each pixel included in the input image. The maximum R, G, B value (pixel value) may be converted into a brightness value by using the relation defined by Expression (1), which will be described later.

The reduced-image generating unit 242 then reduces the input image with a size of 800×400 so as to generate a reduced image with a size of 200×100. A brightness value is set to each pixel of the reduced image, as described above. The reduced-image generating unit 242 may generate a reduced image by using a different method, such as a bi-linear method.

The emission-intensity adjusting unit 243 is a processing unit that adjusts the emission intensity of each of the light sources 220 on the basis of emission pattern data 250a stored in the storage unit 250 so as to prevent excess and deficiency when displaying a reduced image after correction. An explanation is given later of a more detailed configuration and of processing details of the emission-intensity adjusting unit 243.

The emission-intensity control unit 244 is a processing unit that feeds a control amount to each of the drivers 230 in accordance with the adjustment result of the emission-intensity adjusting unit 243 and controls each of the light sources 220 so as to emit light with an intensity according to the adjustment result of the emission-intensity adjusting unit 243.

The image correcting unit 245 is a processing unit that corrects each pixel of an input image in accordance with the rate of change in the intensity of light fed to each pixel of the light control unit 210 according to the adjustment of the emission-intensity adjusting unit 243. Specifically, the brightness and the pixel value have the following proportional relation in a widely used setting.

Brightness∝(Pixel valuê2.2) (1)

Therefore, the image correcting unit 245 calculates the post-correction pixel value by using the following Equation (2):

Post-correction pixel value=Pre-correction pixel value×(1/Light reduction rate)̂(1/2.2) (2)

The transmission-rate control unit 246 is a processing unit that controls the transmission rate of each pixel of the light control unit 210 in accordance with each pixel of the input image that has been corrected by the image correcting unit 245. The storage unit 250 stores various types of information used for the operation of the display control device 240. For example, the storage unit 250 stores the emission pattern data 250a.

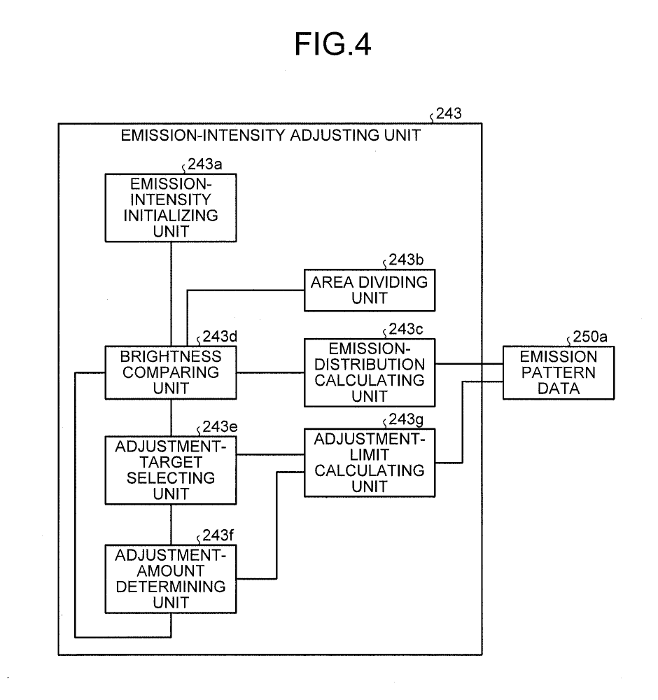

Next, an explanation is given of the more detailed configuration of the emission-intensity adjusting unit 243 illustrated in FIG. 2. FIG. 4 is a block diagram that illustrates the configuration of the emission-intensity adjusting unit 243. As illustrated in FIG. 4, the emission-intensity adjusting unit 243 includes an emission-intensity initializing unit 243a, an area dividing unit 243b, an emission-distribution calculating unit 243c, a brightness comparing unit 243d, an adjustment-target selecting unit 243e, an adjustment-amount determining unit 243f, and an adjustment-limit calculating unit 243g.

The emission-intensity initializing unit 243a is a processing unit that determines the initial value of the emission intensity of each of the light sources 220 with respect to each input image. Specifically, the emission-intensity initializing unit 243a sets the emission intensity of each of the light sources 220 that is determined for the previously displayed input image to be the initial value of each of the light sources 220 for the subsequently input image. For example, in the case of moving images, the previous and subsequent input images (frames) are often similar to each other; therefore, the previous adjustment result is set as the initial value so that the amount of adjustment is low and the adjustment can be completed quickly. If the input image is the first image, the pre-set emission intensity is set as the initial value. Because it is expected that the same adjustment result as the previous one is obtained, it is possible to prevent the occurrence of flicker on the display of the light control unit 210 that is caused due to a change in the adjustment details for each input image.

If the emission intensity of each of the light sources 220 is to be lowered as much as possible, the initial value of the emission intensity of each of the light sources 220 may be set lower by a predetermined amount than the emission intensity of each of the light sources 220 that is determined for the previously displayed input image. With such a setting, due to an emission-intensity adjustment process, which will be described later, the emission intensity of each of the light sources 220 is set to the minimum value for the display of a reduced image. If the process needs to be simplified, the initial value of the emission intensity of each of the light sources 220 may be set to about 90% of the maximum value in a single uniform way.

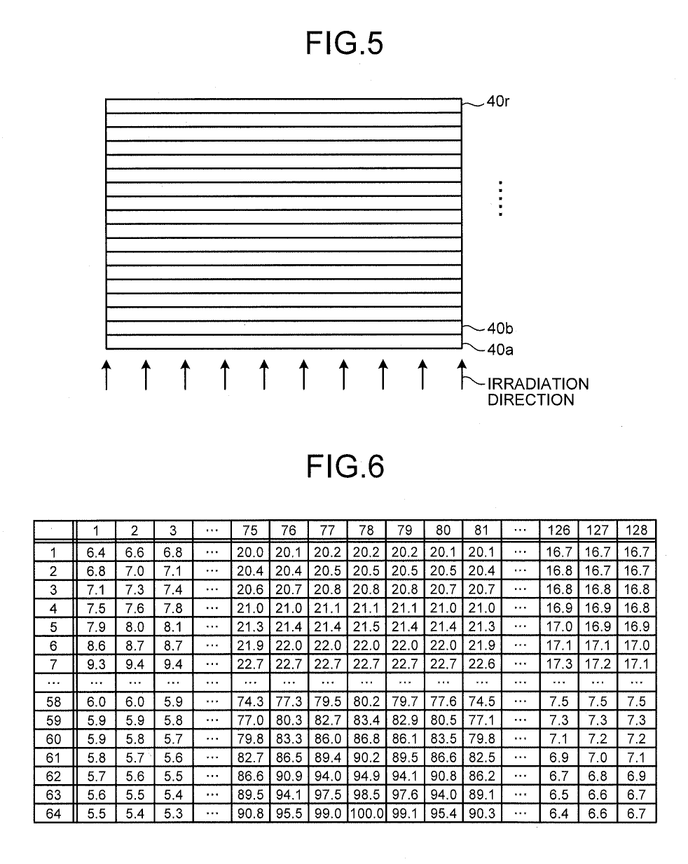

The area dividing unit 243b is a processing unit that divides a reduced image into a plurality of areas by using a straight line that is perpendicular to the irradiation direction. Here, the irradiation direction is the incident direction of light emitted by the light source 220 when the input image corresponding to the reduced image is displayed on the light control unit 210. FIG. 5 is a diagram that illustrates an example of area division of a reduced image. In the example illustrated in FIG. 5, the reduced image is divided into areas 40a to 40r, which are the same size.

For example, if the light sources 220 are arranged on the lower side of the light control unit 210 in a line, the irradiation direction corresponds to the vertical direction of an image and the direction perpendicular to the irradiation direction corresponds to the horizontal direction of an image. As illustrated in FIG. 5, it is possible that the width for dividing an image into a plurality of areas is, for example, 32 to 64 lines. An image may be divided by each line; however, calculation efficiency can be improved if the division width includes a certain number of lines.

The emission-intensity adjusting unit 243 sequentially selects, as an adjustment target, one of the divided areas, starting from the area that is located closest to the irradiation direction. As described above, a pixel that is located closer to the light source 220 receives light from only one or a small number of light sources 220. Therefore, the choices for the light sources 220 whose emission intensities are to be adjusted are few, and because the optimum solution or the near optimum solution is limited, the light reduction amount of the light source 220, which is a target to be preferentially adjusted, needs to be determined. The emission-intensity adjusting unit 243 compares the emission distribution of the light sources 220 at a corresponding area with the brightness value of the reduced image at the corresponding area. Furthermore, the emission-intensity adjusting unit 243 adjusts the emission intensity of each of the light sources 220.

The emission-distribution calculating unit 243c is a processing unit that calculates, by using the emission pattern data 250a, the emission distribution that is obtained by combining the distributions of light fed by all of the light sources 220.

Here, an explanation is given of the emission pattern data 250a. FIG. 6 is a diagram that illustrates an example of an emission pattern. FIG. 6 illustrates, for example, the emission pattern of the light source 220 that is the 10^{th} light source from the right of the 24 light sources 220 that are arranged in a line along the light control unit 210 that is divided into 64×128 in the vertical and horizontal directions. The unit for numbers is cd/m².

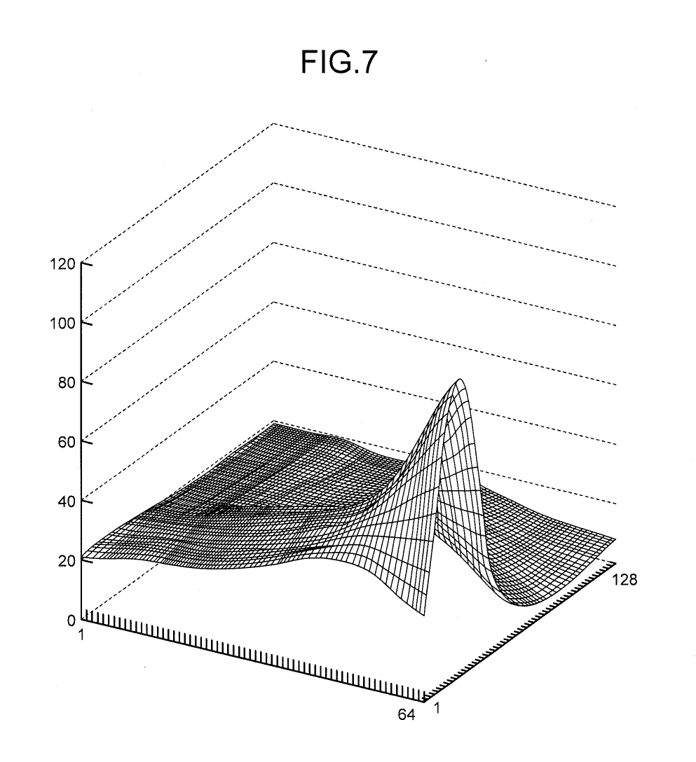

FIG. 7 is a three-dimensional graph of the emission pattern illustrated in FIG. 6. As illustrated in FIGS. 6 and 7, the emission pattern data 250a includes information that indicates how much brightness of the light is fed to which position of the light control unit 210 if each of the light sources 220 is individually turned on with 100% intensity.

The emission-distribution calculating unit 243c multiplies the emission pattern of each of the light sources 220, which is included in the emission pattern data 250a, by the emission intensity of each of the light sources 220 so as to obtain the brightness of the light control unit 210 when each of the light sources 220 is individually turned on. The emission-distribution calculating unit 243c adds the obtained brightness in each position of the light control unit 210 so as to calculate the emission distribution that is obtained when all of the light sources 220 are turned on with their respective emission intensities.

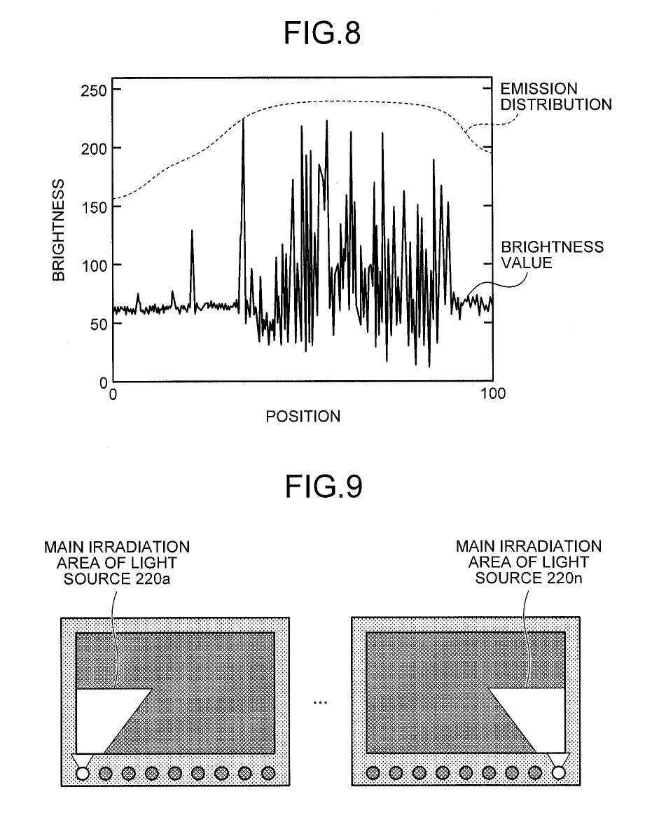

The brightness comparing unit 243d is a processing unit that compares the brightness of a region corresponding to the adjustment target area of each of the light sources 220 in the reduced image with the brightness of the corresponding area in the emission distribution. FIG. 8 illustrates an example of a comparison of the brightness if the area 40a illustrated in FIG. 5 is an adjustment target of each of the light sources 220. FIG. 8 is a graph that illustrates an example of a comparison between the emission pattern and the image. Here, for ease of explanation, the resolution of the reduced image in the direction the light sources are arranged is 100 pixels, and the emission pattern included in the emission pattern data 250a is obtained when the light control unit 210 is divided into 100 sections in the direction the light sources 220 are arranged.

The graph indicated by the solid line in FIG. 8 indicates the brightness value of each pixel that is obtained by scanning, in the arrangement direction, the region corresponding to the area 40a of the reduced image. The graph indicated by the dotted line in FIG. 8 indicates the brightness in the emission distribution in the position corresponding to each pixel of the area 40a. If the area 40a includes a plurality of lines, the brightness comparing unit 243d may use an emission distribution in the position of any one of the lines. The brightness comparing unit 243d compares the emission distribution with the brightness value of the reduced image corresponding to the position of the line that is used.

The brightness comparing unit 243d compares the emission distribution with the brightness value in each position in the arrangement direction. If an area has been found where the brightness of the emission distribution is less than the brightness value of the reduced image, the brightness comparing unit 243d causes the adjustment-target selecting unit 243e to select the light source 220 to be adjusted. The adjustment-amount determining unit 243f then determines how much the emission intensity of the light source 220 selected by the adjustment-target selecting unit 243e is to be increased. The adjustment-amount determining unit 243f sets the emission intensity of the selected light source 220 within the range of the adjustment limit calculated by the adjustment-limit calculating unit 243g.

If an area has not been found where the brightness of the emission distribution is less than the brightness value of the reduced image, the adjustment-target selecting unit 243e selects the light source 220 whose emission intensity can be lowered. If the light source 220 whose emission intensity can be lowered has been selected, the adjustment-amount determining unit 243f determines how much the emission intensity of the light source 220 selected by the adjustment-target selecting unit 243e is to be decreased. The adjustment-amount determining unit 243f sets the emission intensity of the selected light source 220 within the range of the adjustment limit calculated by the adjustment-limit calculating unit 243g.

After the emission intensity of the light source 220 selected by the adjustment-target selecting unit 243e has been adjusted, the emission-distribution calculating unit 243c calculates a new emission distribution that includes the adjustment result of the emission intensity. The brightness comparing unit 243d then compares the new emission distribution with the brightness value of the reduced image. If the light source 220 whose emission intensity can be adjusted is found, the emission intensity of the light source 220 is adjusted and the emission distribution is calculated again. This process is repeated until there are no light sources 220 whose emission intensity can be adjusted.

If there are no light sources 220 whose emission intensity can be adjusted, the same process is performed on the adjacent area that is a target to be adjusted. When all the areas finally have no light sources 220 whose emission intensities can be adjusted, the emission-intensity adjustment process is completed. In the second and subsequent areas, the light source 220 whose emission intensity can be lowered is not selected. This is because, if the emission intensity is reduced in the second and subsequent areas, there is a possibility that an amount of light for displaying a reduced image is insufficient in the area 40a that has been already adjusted.

If the adjustment-target selecting unit 243e has selected the light source 220, the adjustment-limit calculating unit 243g calculates the adjustment limit of the selected light source. Furthermore, the adjustment-limit calculating unit 243g is a processing unit that outputs the calculated adjustment limit to the adjustment-amount determining unit 243f.

The adjustment-limit calculating unit 243g calculates the adjustment limit of each light source by using information on the main irradiation area of each light source. The information on the main irradiation area of each light source is stored in an undepicted memory area. FIG. 9 is a diagram that illustrates an example of the main irradiation area of a light source. The main irradiation area of the light source 220a is illustrated on the left side of FIG. 9, and the main irradiation area of the light source 220n is illustrated on the right side of FIG. 9.

Here, an explanation is given of a case where the adjustment-limit calculating unit 243g calculates the adjustment limit of the light source 220a when the light source 220a has been selected as a target to be adjusted. The adjustment-limit calculating unit 243g multiplies the emission pattern data 250a on each of the light sources 220a by the emission intensity of each of the light sources 220a in the previous frame so as to calculate the emission distribution of the light sources in the previous frame. If there is no previous frame, the emission pattern data 250a on the light source 220a is used without being changed.

The adjustment-limit calculating unit 243g then compares the calculated emission distribution in the previous frame with the main irradiation area of the light source 220a and determines the maximum value of the brightness values of pixels included in the main irradiation area. In the following explanation, the maximum value of the brightness values determined by the adjustment-limit calculating unit 243g is the maximum irradiation brightness Maxk (cd/m²).

Furthermore, the adjustment-limit calculating unit 243g compares the calculated emission distribution in the previous frame with the main irradiation area of the light source 220a and determines the minimum value of the brightness values of pixels included in the main irradiation area. In the following explanation, the minimum value of the brightness values determined by the adjustment-limit calculating unit 243g is the minimum irradiation brightness Mink (cd/m²).

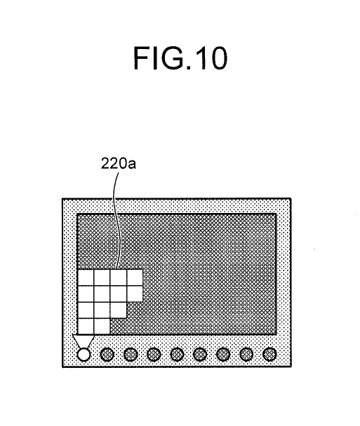

The adjustment-limit calculating unit 243g may subdivide the main irradiation area of the light source 220a into smaller areas. FIG. 10 is a diagram that illustrates an example of an irradiation area that has been subdivided into smaller areas. The adjustment-limit calculating unit 243g multiplies the emission pattern data 250a of each of the light sources 220a by the emission intensity of each of the light sources 220a in the previous frame so as to calculate the emission distribution of the light sources in the previous frame. The adjustment-limit calculating unit 243g compares the calculated emission distribution in the previous frame with the main irradiation area of the light source 220a and calculates the average brightness of each of the smaller areas illustrated in FIG. 10.

The adjustment-limit calculating unit 243g compares the average brightnesses of the smaller areas so as to determine the minimum value of the average brightnesses. The minimum value determined by the adjustment-limit calculating unit 243g may be used as Mink (cd/m²).

The adjustment-limit calculating unit 243g calculates the adjustment limit corresponding to the light source 220a by using the following equation:

Adjustment limit=P×Mink/Maxk (3)

P indicated in Equation (3) is a pre-set constant, and a value from 0.05 to 0.3 is assigned to P. The adjustment-limit calculating unit 243g calculates the adjustment limit of the light source 220 by using, for example, P=0.1. The adjustment-limit calculating unit 243g calculates the adjustment limits of the other light sources 220 in the same manner as that described above.

The adjustment limit calculated by using Equation (3) is a rate at which the emission intensity of each light source may be changed when the displaying of the image in the previous frame is changed to that of the image in the subsequent frame. If the adjustment limit of a light source is “0.1”, the adjustment limit indicates that the emission intensity may be changed within a range of 10% of the emission intensity with which the previous frame is displayed. The adjustment limit may be calculated by using, not only Equation (3), but also an equation for calculating a brightness that allows a change in the emission intensity of each light source.

The adjustment-amount determining unit 243f acquires the adjustment limit from the adjustment-limit calculating unit 243g. If the light source to be adjusted is the light source 220a, the adjustment-amount determining unit 243f determines the adjustment amount of the light source 220a within a plus or minus range of the previous adjustment limit of the light source 220a.

If the value of the adjustment limit is smaller than a threshold, the adjustment-amount determining unit 243f determines the adjustment amount of the light source 220a within a plus or minus range of the threshold, instead of the adjustment limit. If the adjustment limit is too small (or zero), the adjustment-amount determining unit 243f does not change the emission intensity of the light source 220. Therefore, if the adjustment limit is smaller than a threshold, the adjustment-amount determining unit 243f determines the adjustment amount of the light source 220 by using the threshold as a limit.

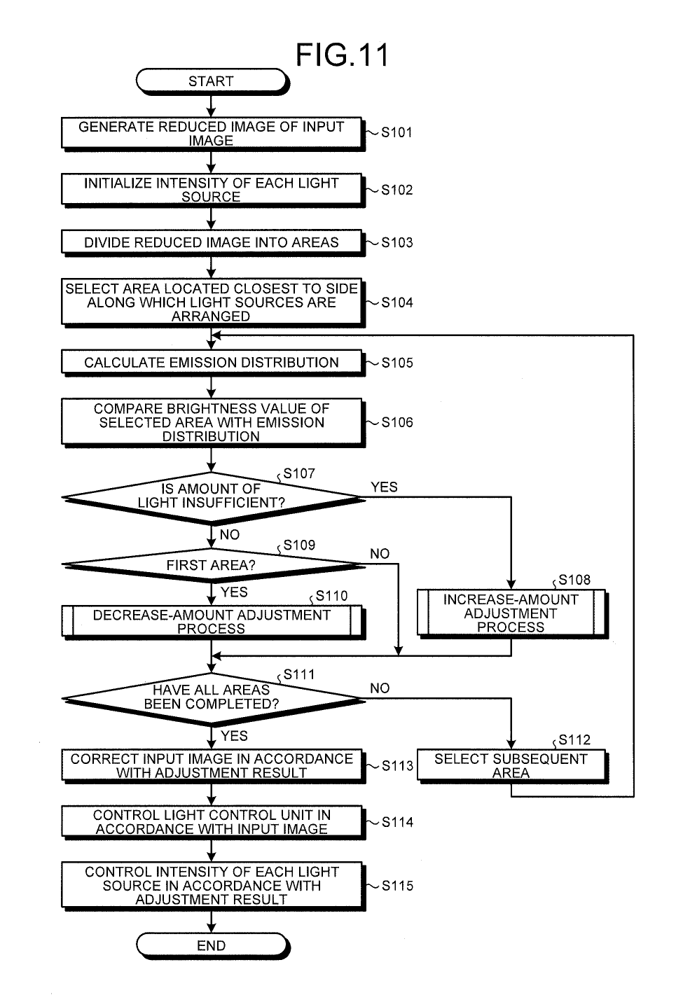

Next, an explanation is given of the steps of a process for adjusting the emission intensity. FIG. 11 is a flowchart that illustrates the steps of the process for adjusting the emission intensity. As illustrated in FIG. 11, the reduced-image generating unit 242 generates a reduced image of the input image (S101). The emission-intensity initializing unit 243a then initializes the emission intensity of each of the light sources 220 (S102).

The area dividing unit 243b divides the reduced image into areas (S103). The emission-intensity adjusting unit 243 selects as an adjustment target, from the divided areas, an area that is located closest to the irradiation direction, i.e., an area that is located closest to the side along which the light sources 220 are arranged during displaying (S104).

The emission-distribution calculating unit 243c calculates the emission distribution (S105). The brightness comparing unit 243d then compares the brightness value (brightness distribution) of the selected area with the brightness of the corresponding area in the emission distribution (S106). If there are any areas for which the amount of light is insufficient (Yes at S107), an increase-amount adjustment process is performed (S108), which will be explained later.

Conversely, if there are no areas for which the amount of light is insufficient (No at S107), and if the selected area is the first area (Yes at S109), a decrease-amount adjustment process is performed (S110), which will be explained later. If the selected area is the second or subsequent area (No at S109), the decrease-amount adjustment process is not performed.

After the process has been completed for the target area to be adjusted, if all of the areas have not been selected as an adjustment target (No at S111), the subsequent area is selected (S112) and the process is resumed from S105.

Conversely, if all of the areas have been selected as an adjustment target (Yes at S111), the image correcting unit 245 corrects the image in accordance with the adjustment result (S113). The transmission-rate control unit 246 then controls the transmission rate of each pixel of the light control unit 210 in accordance with the corrected input image (S114). The emission-intensity control unit 244 controls the emission intensity of each of the light sources 220 in accordance with the adjustment result (S115).

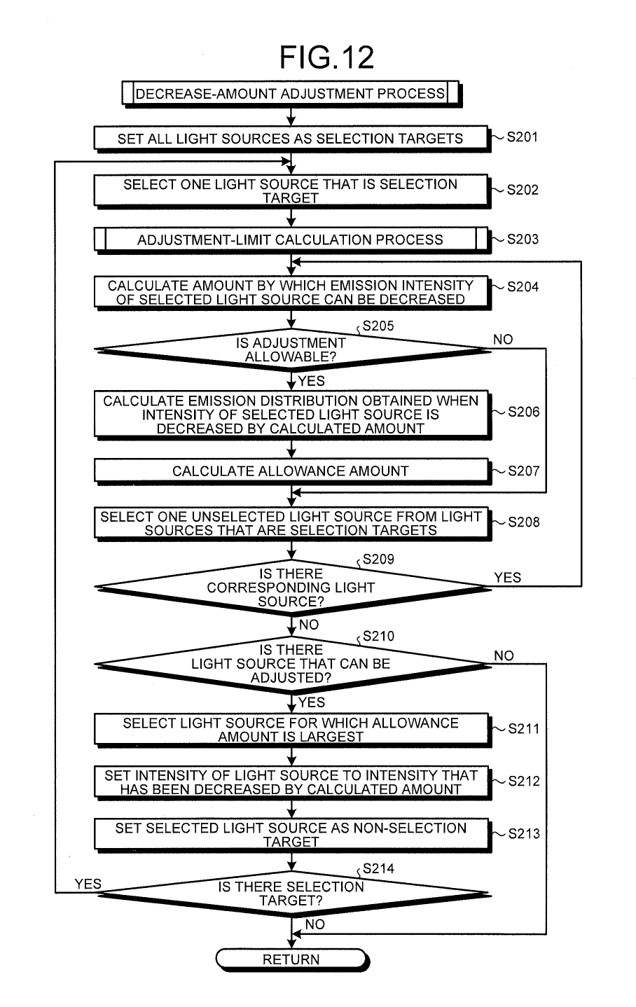

Next, an explanation is given of the steps of the decrease-amount adjustment process illustrated at S110 of FIG. 11. FIG. 12 is a flowchart that illustrates the steps of the decrease-amount adjustment process. As illustrated in FIG. 12, the emission-intensity adjusting unit 243 first sets all of the light sources 220 as targets to be selected (S201). The emission-intensity adjusting unit 243 selects one of the light sources 220 that are the targets to be selected (S202) and performs a process for calculating an adjustment limit (S203).

The adjustment-amount determining unit 243f calculates the amount by which the emission intensity of the selected light source 220 can be decreased within the range of the adjustment limit (S204). If the emission intensity of the selected light source 220 can be decreased (Yes at S205), the emission-distribution calculating unit 243c calculates the emission distribution that is obtained when the emission intensity of the selected light source 220 is decreased by the calculated amount (S206). By using the calculated emission distribution, the adjustment-amount determining unit 243f calculates, as an allowance amount, a total of the amounts of the emission intensities of the other light sources 220 that can be decreased within the range of the adjustment limits (S207).

Conversely, if the emission intensity of the light source 220 can not be decreased (No at S205), the allowance amount is not calculated.

The emission-intensity adjusting unit 243 then selects an unselected light source from the light sources 220 that are the targets to be selected (S208). If an unselected light source 220 can be selected (Yes at S209), the process is resumed from S204.

Conversely, if an unselected light source 220 is not selected, i.e., if checking has been completed for all of the light sources 220 that are the targets to be selected (No at S209), the emission-intensity adjusting unit 243 checks whether there is a light source 220 for which the emission intensity can be decreased (S210). If there is no light source 220 for which the emission intensity can be decreased (No at S210), the decrease-amount adjustment process is terminated.

Conversely, if there is a light source 220 for which the emission intensity can be decreased (Yes at S210), the adjustment-target selecting unit 243e selects the light source 220 for which the allowance amount is largest as a target to be adjusted (S211). The adjustment-amount determining unit 243f then sets the emission intensity of the light source 220 to the emission intensity that has been decreased by the calculated decrease amount (S212). The emission-intensity adjusting unit 243 then sets the light source 220 as a non-selection target (S213). If there is a light source 220 that is a target to be selected (Yes at S214), the process is resumed from S202. If there is no light source 220 (No at S214), the decrease-amount adjustment process is terminated.

In the above-described process steps, the emission intensity of the light source 220 is decreased in descending order of the allowance amounts so that the overall decrease amount can be larger; however, in order to simplify the process, the emission intensity may be decreased, starting with the light source whose emission intensity can be decreased the most. Furthermore, in order to prevent the occurrence of brightness variation, or the like, adjustment may be made such that the difference between the decrease amounts of the emission intensities of the light source 220 and the adjacent light source 220 is equal to or less than a predetermined amount.

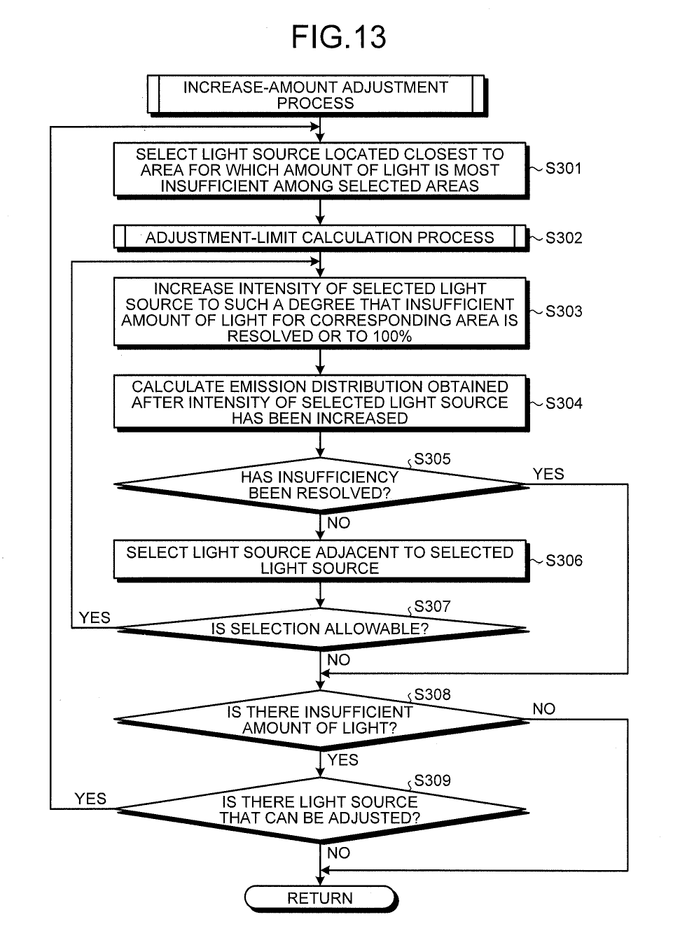

Next, an explanation is given of the steps of the increase-amount adjustment process illustrated at S108 of FIG. 11. FIG. 13 is a flowchart that illustrates the steps of the increase-amount adjustment process. As illustrated in FIG. 13, the brightness comparing unit 243d finds an area for which the amount of light is the most insufficient by using the line information on the area selected as an adjustment target. The adjustment-target selecting unit 243e selects as an adjustment target the light source 220 that is located closest to the area (S301).

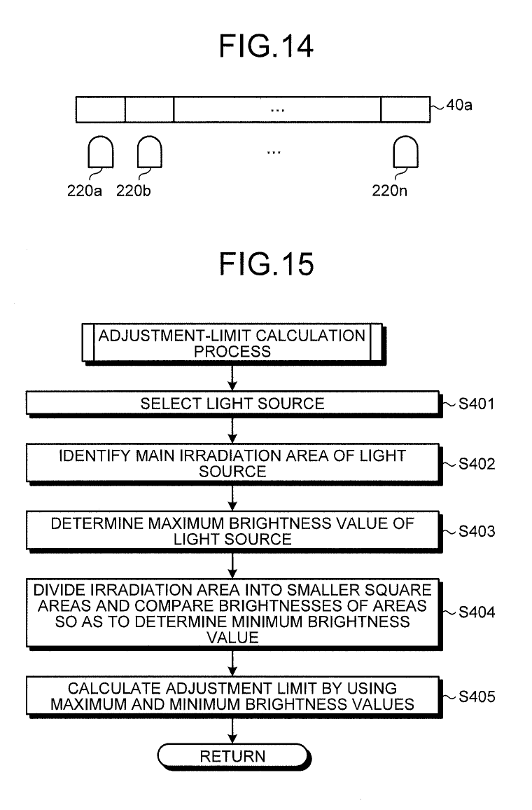

As illustrated in FIG. 14, the light source 220 that is located closest to the area for which the amount of light is insufficient can be selected easily if the area selected as an adjustment target is divided into the number of areas corresponding to the number of light sources 220, as illustrated in FIG. 14. FIG. 14 is a diagram that illustrates an example of area division to select a light source that is located closest to the area for which the amount of light is the most insufficient.

The adjustment-limit calculating unit 243g performs the process for calculating an adjustment limit (S302). The adjustment-amount determining unit 243f increases the emission intensity of the light source 220, which has been selected as an adjustment target, to such a degree that the insufficient amount of light for the area is resolved or to 100% (S303). Then, the emission-distribution calculating unit 243c calculates the emission distribution that is obtained after the emission intensity of the light source 220, which has been selected as an adjustment target, has been increased (S304).

The brightness comparing unit 243d determines whether the insufficient amount of light for the area has been resolved. If it has not been resolved (No at S305), the adjustment-target selecting unit 243e selects, as a new adjustment target, the light source 220 that is adjacent to the light source 220 that has been selected as an adjustment target (S306).

Here, light sources A to E are arranged in the order of A, B, C, D, and E. If the light source C is first selected as an adjustment target, the other light sources are selected in the order of B, D, A, and E or the order of D, B, E, and A.

If the adjacent light source 220 can be selected as a new adjustment target (Yes at S307), the process is resumed from S303.

Conversely, if there is no light source 220 that can be selected as a new adjustment target (No at S307), or if the insufficient amount of light for the area has been resolved at S305 (Yes at S305), the brightness comparing unit 243d finds a different area for which the amount of light is most insufficient from the areas selected as adjustment targets (S308).

If the brightness comparing unit 243d has found the corresponding area (Yes at S308), and if there is the light source 220 for which the emission intensity can be adjusted (Yes at S309), the process is resumed from S301. Conversely, if there is no area for which the amount of light is insufficient (No at S308), or if there is no light source 220 for which the emission intensity can be adjusted (No at S309), the increase-amount adjustment process is terminated.

Next, an explanation is given of the steps of a process for calculating the adjustment limit, which is illustrated at S302 in FIG. 13. FIG. 15 is a flowchart that illustrates the steps of the process for calculating the adjustment limit. The adjustment-target selecting unit 243e selects the light source 220 (S401), and the adjustment-limit calculating unit 243g identifies the main irradiation area of the light source 220 (S402).

The adjustment-limit calculating unit 243g determines the maximum value Maxk (S403). The adjustment-limit calculating unit 243g divides the irradiation area into smaller square areas and compares the brightnesses of the areas so as to determine the minimum brightness value Mink (S404). The adjustment-limit calculating unit 243g calculates the adjustment limit by using the maximum and minimum brightness values (S405).

As described above, in the display device 200 according to the second embodiment, when determining the emission intensity of the light source 220, the emission-intensity adjusting unit 243 determines the maximum value and the minimum value of the brightness values included in the main irradiation area of the light source 220. The emission-intensity adjusting unit 243 calculates the adjustment limit on the basis of the determined maximum and minimum values and adjusts the emission intensity of the light source within the range of the adjustment limit. With the above-described configuration, in the display device that includes a plurality of light sources whose irradiation areas are not separated, the adjustment limit of alight source can be determined in consideration of the irradiation from the other light sources. As a result, it is possible to effectively prevent flicker.

Flicker occurs in an area where the difference between light and dark areas is large. The brightness gradient is visually recognized as a shape with the brightness distribution, which often results in flicker. Therefore, the adjustment limit is calculated by additionally taking into consideration the brightness gradient of the main irradiation area so that it is possible to ensure the avoidance of flicker that is caused due to a change in the emission intensity of a light source that covers an area with large brightness gradient.

### [c] Third Embodiment

An explanation is given so far of the embodiments of the present invention; however, the present invention may be embodied in various different forms other than the first and second embodiments. A different embodiment of the present invention is explained below as a third embodiment.

(1) Adjustment Limit

For example, the adjustment-limit calculating unit 243g determines the maximum value Maxk and the minimum value Mink from the main irradiation area of the light source 220 and calculates the adjustment limit by using Equation (3); however, the present invention is not limited to this. The adjustment-limit calculating unit 243g may determine Mink of the main irradiation area in the previous frame without performing a process for determining Maxk. The adjustment-limit calculating unit 243g may consider only the minimum value Mink and calculate the adjustment limit by using the following equation:

Adjustment limit=P×Mink (4)

In this case, the amount of calculation can be reduced. Because the minimum value Mink is used as it is used in Equation (3), the adjustment limit can be lowered compared to the adjustment limit calculated by using a different value. Thus, it is possible to reduce the amount of calculation and prevent the occurrence of flicker.

Furthermore, the adjustment-limit calculating unit 243g may determine only the maximum value Maxk and calculate the adjustment limit on the basis of the maximum value Maxk. In this case, the emission intensity of each light source can be adjusted in a more dynamic manner.

(2) Configuration of System, and the Like

The configuration of the display device 200 according to the present embodiment, which is illustrated in FIG. 2, can be changed variously without departing from the scope of the present invention. For example, the function of the display control device 240 of the display device 200 can be implemented as software and the software executed by a computer so that the same function as that of the display control device 240 can be performed. The following is an example of a computer that executes a display control program in which the function of the display control device 240 is implemented as software.

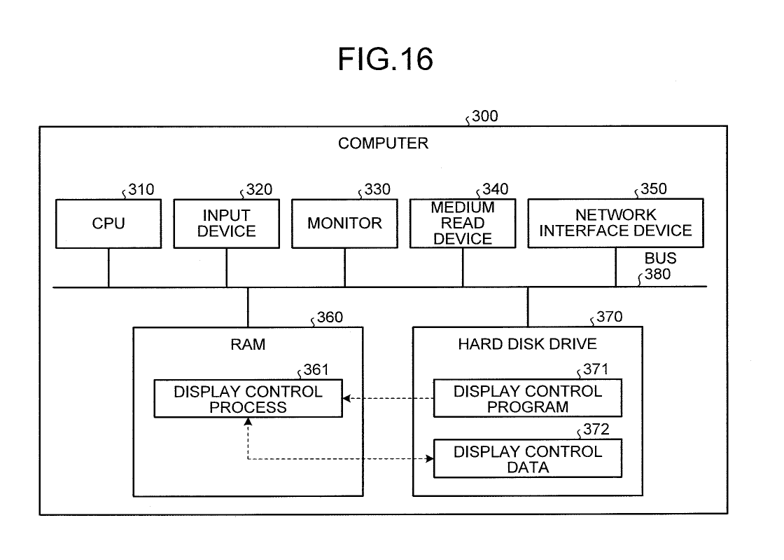

FIG. 16 is a functional block diagram that illustrates a computer that performs the display control program. A computer 300 includes a Central Processing Unit (CPU) 310 that performs various calculation processes; an input device 320 that receives an input of data from a user; and a monitor 330 that includes the light control unit 210. The computer 300 further includes a medium read device 340 that reads programs, and the like, from a storage medium; a network interface device 350 that receives data from a different computer via a network; a Random Access Memory (RAM) 360 that temporarily stores various types of information; and a hard disk drive 370. Each of the devices 310 to 370 is connected to a bus 380.

The hard disk drive 370 stores a display control program 371 that has the same function as the display control device 240 illustrated in FIG. 2 and stores display control data 372 that corresponds to various types of data stored in the storage unit 250 illustrated in FIG. 2. The display control data 372 may be distributed as appropriate and stored in a different computer that is connected via a network.

The CPU 310 reads the display control program 371 from the hard disk drive 370 and loads the read display control program 371 into the RAM 360 so that the display control program 371 functions as a display control process 361. The display control process 361 loads information, or the like, read from the display control data 372 into an area assigned to the display control process 361 in the RAM 360 as appropriate and performs various data processes by using the loaded data, or the like.

The above-described display control program 371 does not always need to be stored in the hard disk drive 370. A program stored in a storage medium, such as CD-ROM, may be read and executed by the computer 300. Moreover, the program may be stored in a public line, the Internet, a Local Area Network (LAN), a Wide Area Network (WAN), or the like, and read and executed by the computer 300.

In a display device that includes a plurality of light sources whose irradiation areas are not separated, the adjustment limit of a light source can be determined in consideration of the irradiation from the other light sources. As a result, according to the present invention, it is possible to effectively prevent flicker.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A display device comprising:
a plurality of light sources whose irradiation areas are overlapped with one another;
an image display area that includes areas that are pre-set for the respective light sources;
a calculating unit that calculates an adjustment limit of the amount of emission of each of the light sources corresponding to each of the areas when a display target image is displayed, the adjustment limit being calculated on the basis of the irradiation brightness of the area that is obtained when the previous display target image of the display target image is displayed; and
a control unit that controls the amount of light of each of the light sources in accordance with the adjustment limit.

2. The display device according to claim 1, wherein the calculating unit calculates the adjustment limit on the basis of a minimum irradiation brightness of each of the areas.

3. The display device according to claim 2, wherein
the area includes a plurality of smaller areas, and
the calculating unit determines a representative irradiation brightness of each of the smaller areas and sets a minimum representative irradiation brightness of the representative irradiation brightnesses to the minimum irradiation brightness.

4. The display device according to claim 2, wherein the calculating unit calculates the minimum irradiation brightness and a maximum irradiation brightness of each of the areas and calculates the adjustment limit on the basis of the minimum irradiation brightness and the maximum irradiation brightness.

5. The display device according to claim 1, further comprising a comparing unit that compares the adjustment limit with a threshold, wherein
if the adjustment limit is less than the threshold, the control unit controls the light intensity of each of the light sources on the basis of the threshold.

6. A control method performed by a display device, the control method comprising:
calculating an adjustment limit of the amount of emission of each of a plurality of light sources whose irradiation areas are overlapped with one another, the light sources corresponding to each of a plurality of areas included in an image display area, the image display area being pre-set for the respective light sources when a display target image is displayed, the adjustment limit being calculated on the basis of the irradiation brightness of the area that is obtained when the previous display target image of the display target image is displayed on the image display area; and
controlling the amount of light of each of the light sources in accordance with the adjustment limit.

7. The control method according to claim 6, wherein the calculating includes calculating the adjustment limit on the basis of a minimum irradiation brightness of each of the areas.

8. The control method according to claim 7, wherein
the area includes a plurality of smaller areas, and
the calculating includes determining a representative irradiation brightness of each of the smaller areas and includes setting a minimum representative irradiation brightness of the representative irradiation brightnesses to the minimum irradiation brightness.

9. The control method according to claim 7, wherein the calculating includes calculating the adjustment limit on the basis of the minimum irradiation brightness and a maximum irradiation brightness of each of the areas.

10. The control method according to claim 6, further comprising comparing the adjustment limit with a threshold, wherein
if the adjustment limit is less than the threshold, the controlling includes controlling the light intensity of each of the light sources on the basis of the threshold.

11. A display device comprising:
a plurality of light sources whose irradiation areas are overlapped with one another;
an image display area that includes areas that are pre-set for the respective light sources;
a processor; and
a memory, wherein the processor executes:
calculating an adjustment limit of the amount of emission of each of the light sources corresponding to each of the areas when a display target image is displayed, the adjustment limit being calculated on the basis of the irradiation brightness of the area that is obtained when the previous display target image of the display target image is displayed on the image display area; and
controlling the amount of light of each of the light sources in accordance with the adjustment limit.
